(19) United States
(12) Patent Application Publication
(10) Pub. No.: US 2011/0195381 A1
(43) Pub. Date: Aug. 11, 2011

(54) Association-recognition teaching tool and method

(76) Inventor: Barbara J. Ciletti, Longmont, CO (US)

(21) Appl. No.: 12/931,577

(22) Filed: Feb. 4, 2011

Related U.S. Application Data
(60) Provisional application No. 61/337,635, filed on Feb. 9, 2010.

(51) Int. Cl. G09B 11/00

(52) U.S. Cl. 434/81

(57) ABSTRACT

An association-recognition teaching tool and method of use thereof for teaching image recognition among a plurality of substantially functionally unrelated items. The tool includes a first functional item bearing an image thereon and at least one additional functional item whose function is substantially unrelated to the first functional item and wherein the at least one additional functional item bears a substantially identical image as that upon the first functional item, and further wherein the first functional item and the at least one additional functional item are bundled within a single package.

### CROSS-REFERENCE TO RELATED APPLICATIONS

Claims filing date of Feb. 9, 2010 of Provisional Patent Application Ser. No. 61/337635

### FEDERALLY SPONSORED RESEARCH/DEVELOPMENT

None

### BACKGROUND OF THE INVENTION

The present invention relates in general to association-recognition teaching, and in particular to an association-recognition teaching tool and method wherein functionally unrelated items are provided with substantially identical images to thereby instill in a student an ability to search for and ultimately recognize both differences and similarities among all items.

While it is certainly important to recognize differences among objects, it is likewise equally important to have an ability to recognize likenesses among those same objects. Small children are able to appreciate the differences between two functionally unrelated objects such as a book and a bath towel, but generally are not adept at searching to find likenesses between the two. Thus, for example, the cover of a book and a bath towel may each be white, but a young child typically only sees a book and a towel without noting that the two are identical to each other with respect to their color.

However, the ability to recognize likenesses as well as differences is essential in cognitive thinking throughout a lifetime. Therefore, a primary object of the teaching tool and method here described and claimed is to provide help in accomplishing an early cognitive regimen upon which continued growth thereof can be built through such early introduction of basic principles of thoughtful inspection of objects and, by association, hopefully thoughtful analysis of seemingly opposite written or spoken expressed points of view, before declaring that no similarities exist.

### SUMMARY OF THE INVENTION

The present invention is an association-recognition teaching tool and its use for teaching image recognition among a plurality of substantially functionally unrelated items. The tool comprises a first functional item bearing an image thereon and at least one additional functional item whose function is substantially unrelated to the first functional item, and wherein the at least one additional functional item bears a substantially identical image as that upon the first functional item. The functional items are non-limitedly chosen from the group consisting of books, toys, blankets, clothing, and substrates capable of bearing an image. The teaching tool members are preferably packaged as a single bundle to thereby allow a child to easily carry and have available all of the members thereof to thus reinforce association recognition as the child relates to the bundle.

Employment of the teaching tool provides a method of teaching association recognition among a plurality of substantially functionally unrelated items. The method comprises presentment of a first functional item bearing an image thereon and subsequent presentment of at least one additional functional item whose function is substantially unrelated to the first functional item and wherein the at least one additional functional item bears a substantially identical image as that upon the first functional item. In such manner the learner is exposed to a thought pattern to include a concept that similarities can exist in two or more functionally divergent items.

### BRIEF SUMMARY OF THE DRAWINGS

An illustrative and presently preferred embodiment of the invention is shown in the accompanying drawings in which:

FIG. 1 illustrates a cover of a children's picture book;

FIG. 2 illustrates a quilt with a border design;

FIG. 3 illustrates a quilt without a border design; and

FIG. 4 illustrates the inclusion of the members of FIGS. 1-3 within a package bundle.

### DETAILED DESCRIPTION OF THE INVENTION

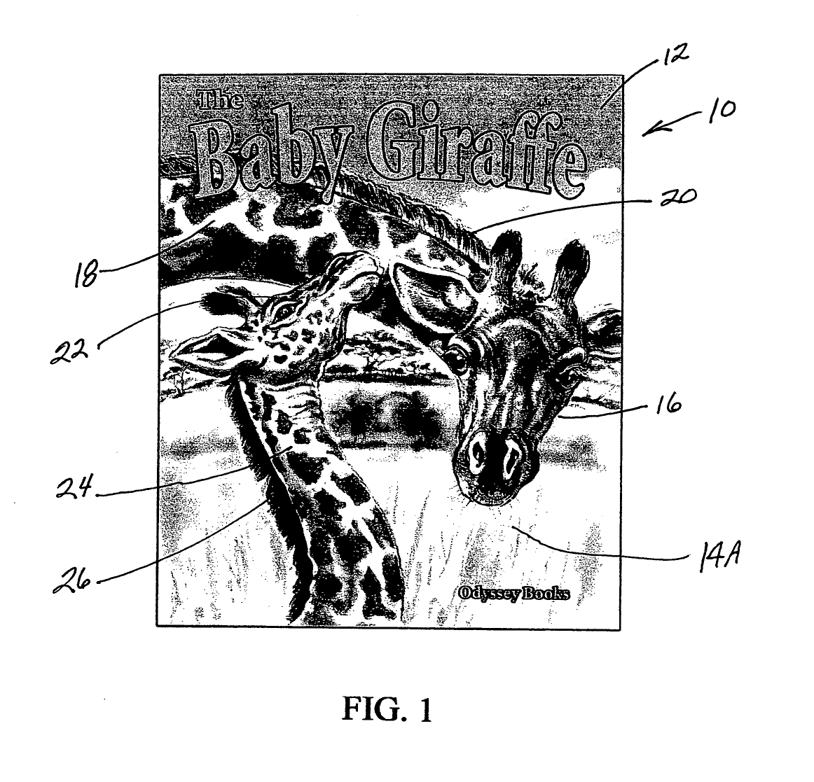

FIG. 1 illustrates a children's picture book 10 having a cover 12 whereupon an image 14A comprising a head 16 and neck portion 18 of a larger giraffe 20 and a head 22 and neck portion 24 of a smaller giraffe 26 are shown.

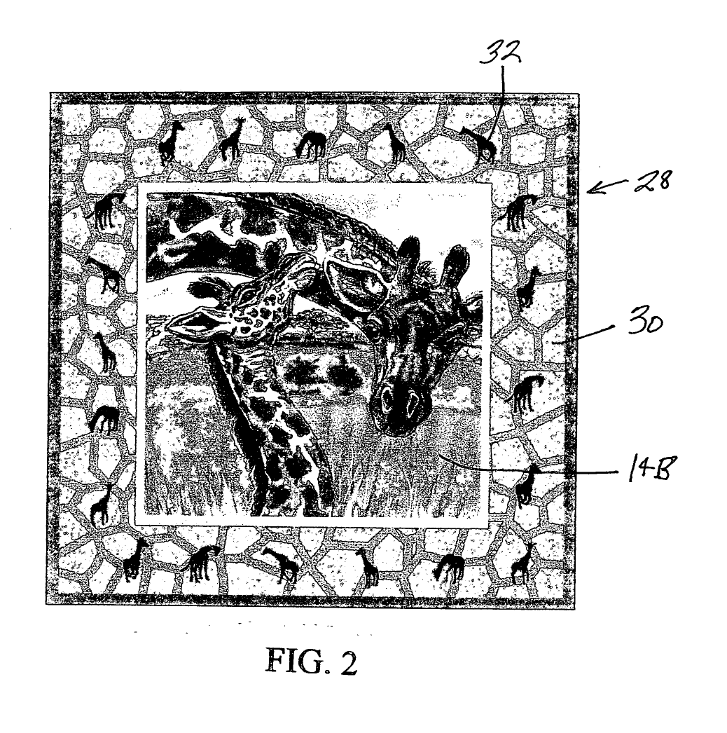

In contrast to the function of the book 10 having the cover 12 with the image 14A thereon as described, a functionally unrelated first quilt 28 with an image 14B is illustrated in FIG. 2. As is apparent, despite the non-related functionality of the quilt 28 to the book 12, each bears substantially identical images 14A and 14B. Additionally, the quilt 28 includes a border 30 having thereon a plurality of full bodies 32 of giraffes which function to reinforce the primary image 14B of the quilt 28.

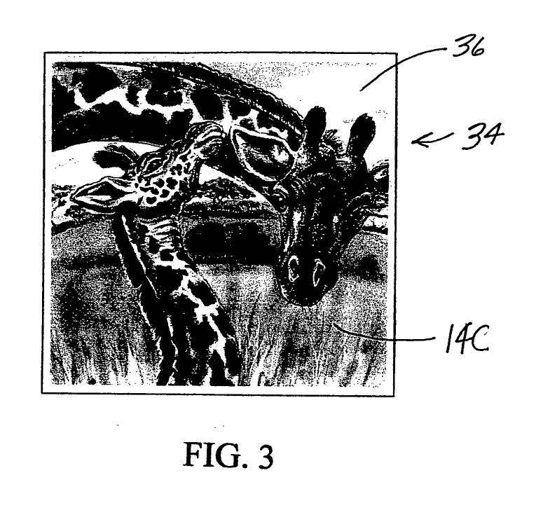

Finally, in FIG. 3, a smaller second quilt 34 is shown, wherein the entire face 36 thereof bears an image 14C which is substantially identical to images 14A and 14B as illustrated in FIGS. 1 and 2. Because the second quilt 34 is smaller than the first quilt 28, its functionality with respect to the first quilt 28 is certainly modified while its functionality to the book 10 is unrelated.

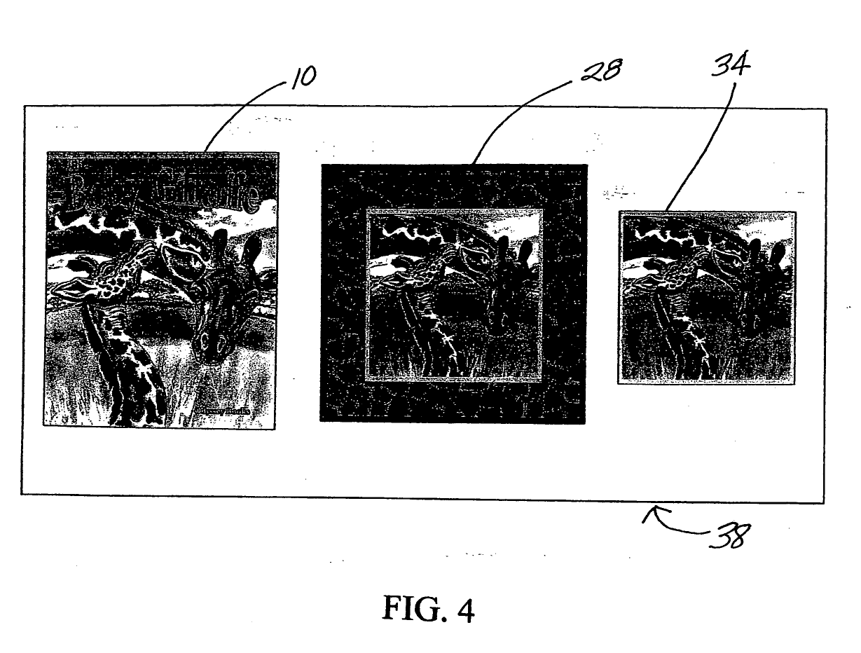

FIG. 4 illustrates the preferred package bundling of all of the members of the teaching tool. Thus, a flexible-wall package 38 is graphically depicted wherein the book 10 and the differing quilts 28, 34 all reside within the package 38 for easy transport by a child.

While an illustrative and presently preferred embodiment of the invention has been described in detail herein, it is to be understood that the inventive concepts may be otherwise variously embodied and employed, and that the appended claims are intended to be construed to include such variations except insofar as limited by prior art.

What is claimed is:

1. An association-recognition teaching tool for teaching image recognition among a plurality of substantially functionally unrelated items, the tool comprising a first functional item bearing an image thereon and at least one additional functional item whose function is substantially unrelated to said first functional item and wherein said at least one additional functional item bears a substantially identical image as that upon the first functional item, and further wherein said first functional item and said at least one additional functional item are bundled within a single package.

2. An association-recognition teaching tool as claimed in claim 1 wherein the plurality of functional items are chosen from the group consisting of books, toys, blankets, clothing, and substrates capable of bearing an image.

3. A method of teaching association recognition among a plurality of substantially functionally unrelated items, the method comprising presentment of a first functional item bearing an image thereon and subsequent presentment of at least one additional functional item whose function is substantially unrelated to said first functional item and wherein said at least one additional functional item bears a substantially identical image as that upon the first functional item.

4. A method of teaching association recognition as claimed in claim 3 wherein the plurality of substantially functionally unrelated items are chosen from the group consisting of books, toys, blankets, clothing, and substrates capable of bearing an image.
